(19) United States
(12) Patent Application Publication
(10) Pub. No.: US 2004/0161034 A1
(43) Pub. Date: Aug. 19, 2004

(54) Method and apparatus for perceptual model based video compression

(76) Inventors: Andrei Morozov, Mountain View, CA (US); Ilya Asnis, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/366,863

(22) Filed: Feb. 14, 2003

(51) Int. Cl. H04N 7/12

(52) U.S. Cl. 375/240.03; 375/240.01; 375/240.12; 375/240.2

(57) ABSTRACT

A method and apparatus for perceptual model based video compression calculates a bitrate value that follows with stabilizing delay the actual bitrates of previous frames. A current quantization coefficient is determined with the calculated bitrate value and a perceptual model. The current quantization coefficient's rate of change is limited based on a previous quantization coefficient. After the current quantization coefficient has been calculated and limited, a current frame is encoded with the limited current quantization coefficient.

### FIELD OF THE INVENTION

The invention relates to the field of video compression. More specifically, the invention relates to perceptual model based still image and/or video data compression.

### BACKGROUND OF THE INVENTION

Digital video contains a large amount of information in an uncompressed format. Manipulation and/or storage of this large amount of information consumes both time and resources. On the other hand, a greater amount of information provides for better visual quality. The goal of compression techniques is typically to find the optimum balance between maintaining visual quality and reducing the amount of information necessary for displaying a video.

In order to reduce the amount of information necessary to display video, compression techniques take advantage of the human visual system. Information that cannot be perceived by the human eye is typically removed. In addition, information is often repeated across multiple frames in a video sequence. To reduce the amount of information, redundant information is also removed from a video sequence. A video compression technique is described in detail in the Moving Pictures and Experts Group-2 (MPEG-2) standard, described in ISO/IEC 13818-2, “Information technology—generic coding of moving pictures and associated audio information: Video, 1996.”

Typically MPEG-2 encoders are developed to perform in constant bitrate (CBR) mode, where the average rate of the video stream is almost the same from start to finish. A video stream includes a plurality of pictures or frames of various types, such as I, B and P picture types as defined by the MPEG-2 standard. A picture, depending on its type, may consume more or less bits than the set target rate of the video stream. The CBR rate-control strategy has the responsibility of maintaining a bit ratio between the different picture types of the stream, such that the desired average bitrate is satisfied, and a high quality video sequence is displayed.

Other encoders, including other MPEG-2 encoders, perform in a variable bitrate (VBR) mode. Variable bitrate encoding allows each compressed picture to have a different amount of bits based on the complexity of intra and inter-picture characteristics. For example, the encoding of scenes with simple picture content will consume significantly less bits than scenes with complicated picture content, in order to achieve the same perceived picture quality.

Conventional VBR encoding is accomplished in non-real time using two or more passes because of the amount of information that is needed to characterize the video and the complexity of the algorithms needed to interpret the information to effectively enhance the encoding process. In a first pass, encoding is performed and statistics are gathered and analyzed. In a second pass, the results of the analysis are used to control the encoding process. Although this produces a high quality compressed video stream, it does not allow for real-time operation, nor does it allow for single pass encoding.

### BRIEF SUMMARY OF THE INVENTION

A method and apparatus for perceptual model based video compression is described. According to one aspect of the invention, a bitrate value that follows with stabilizing delay the actual bitrates of previous frames is calculated. A current quantization coefficient is determined with the calculated bitrate value and a perceptual model. The current quantization coefficient's rate of change is limited based on a previous quantization coefficient. After the current quantization coefficient has been calculated and limited, a current frame is encoded with the limited current quantization coefficient.

These and other aspects of the present invention will be better described with reference to the Detailed Description and the accompanying Figures.

### BRIEF DESCRIPTION OF THE DRAWINGS

The invention may best be understood by referring to the following description and accompanying drawings that are used to illustrate embodiments of the invention. In the drawings:

FIG. 1 is a graph illustrating perceptual models according to one embodiment of the invention.

FIG. 2 is a diagram illustrating determination of an encoding complexity control scalar based on a non-tailored perceptual model according to one embodiment of the invention.

FIG. 3 is an exemplary flowchart for determining a stabilized previous encoding based bitrate according to one embodiment of the invention.

FIG. 4 is an exemplary diagram of an encoding complexity control scalar generation unit and an encoder according to one embodiment of the invention.

FIG. 5 is an exemplary diagram of an encoding complexity control scalar generation unit according to one embodiment of the invention.

FIG. 6 is a graph illustrating target bit utilization range over a video sequence according to one embodiment of the invention.

FIG. 7 is a diagram illustrating conceptual interaction between a bit utilization graph and a perceptual model according to one embodiment of the invention.

FIG. 8 is an exemplary flowchart for calculating any perceptual model defining parameter according to one embodiment of invention.

FIG. 9A is a flowchart for calculating an encoding complexity control scalar based on a bit utilization control adaptive perceptual model according to one embodiment of invention.

FIG. 9B is a flowchart continuing from the flowchart of FIG. 9A according to one embodiment of the invention.

FIG. 10 is an exemplary diagram of an encoding complexity control scalar generation unit with a perceptual model defining parameter module according to one embodiment of the invention.

FIG. 11 is an exemplary diagram of a system with an encoding complexity control scalar generation unit according to one embodiment of the invention.

### DETAILED DESCRIPTION OF THE INVENTION

In the following description, numerous specific details are set forth to provide a thorough understanding of the invention. However, it is understood that the invention may be practiced without these specific details. In other instances, well-known circuits, structures, standards, and techniques have not been shown in detail in order not to obscure the invention.

Overview

Methods and apparatuses for perceptual model based video compression are described. According to various embodiments of the invention, an encoding complexity control scalar (e.g., a quantization coefficient), which is used for compression (also referred to as encoding), is determined based on a perceptual model. A set of one or more parameters, based on previously encoded frames, defines the perceptual model used for determining the encoding complexity control scalar for encoding a current frame.

According to one embodiment of the invention, the perceptual model used for determining the encoding complexity control scalar is defined by a set of parameters that includes a stabilized previous encodings based bitrate. The stabilized previous encodings based bitrate is calculated from a time weighed average of past non-transition frame bitrates, which is stabilized by compensating for transition frame bitrates. A video sequence compressed with perceptual model based encoding is perceived by the human eye as having a consistent visual quality, despite differences between frames, which typically cause noticeable changes in visual quality of the video sequence. Using information from preceding encodings to generate an encoding complexity control scalar for encoding a current frame enables real-time single pass VBR encoding.

According to another embodiment of the invention, the perceptual model used for determining the encoding complexity control scalar is defined by a perceptual model defining encoding complexity control scalar calculated from the remaining available encoding bits in a sequence bit budget and perceptual model correction parameters. Redefining or adjusting the perceptual model in light of past bit utilization to maintain current and/or future bit utilization within a range provides for smooth bit utilization and perceptual integrity.

In another embodiment of the invention, the perceptual model is defined or adjusted in accordance with a stabilized time weighed previous encodings based bitrate and a perceptual model defining encoding complexity control scalar. The perceptual model defining encoding complexity control scalar shifts the perceptual model in accordance with bit utilization to provide an even bit utilization that maintains perceptual integrity. The encoding complexity control scalar determined from the shifting perceptual model and a stabilized time weighed preceding encodings based bitrate provides encoding complexity control scalars for encoding a current frame of a video sequence that will be perceived as having consistent visual quality.

Generating an Encoding Complexity Control Scalar Based on Previous Bitrates

As previously discussed, an encoding complexity control scalar used to encode a frame in a video sequence is determined based on a perceptual model. A perceptual model can be plotted on a graph with coordinates defined by bitrate and encoding complexity control scalar. A bitrate is calculated based on preceding encoding bitrates. After the preceding encodings based bitrate is calculated, an encoding complexity control scalar that corresponds to the calculated preceding encodings based bitrate according to the perceptual model is determined.

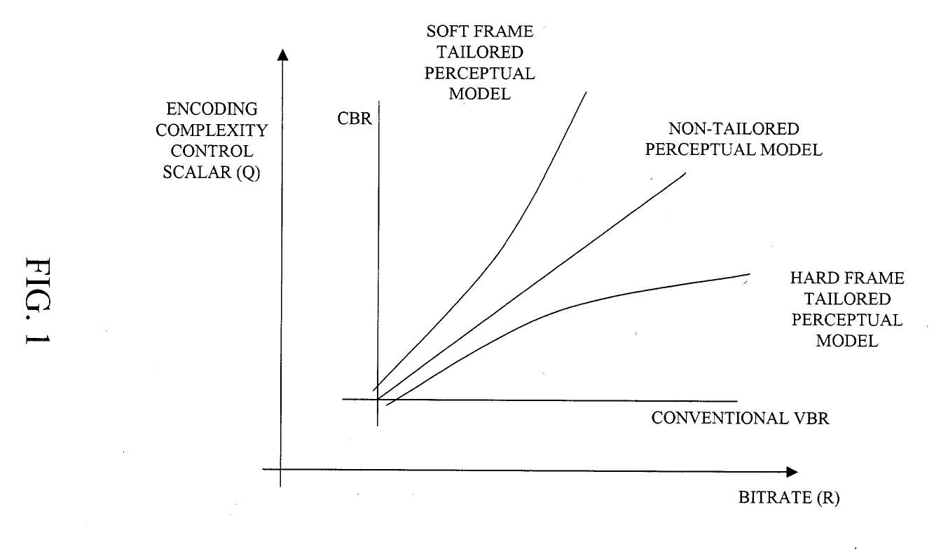

FIG. 1 is a graph illustrating perceptual models according to one embodiment of the invention. In FIG. 1, an x-axis is defined by bitrate (R) and a y-axis is defined by encoding complexity control scalar (Q). The graph includes a soft-frame tailored perceptual model, a non-tailored perceptual model, and a hard frame tailored perceptual model. According to one embodiment of the invention, each of the perceptual models is defined by the following equation: Q_{CALC}=Q_{PM}*(R_{CALC}/R_{PM})^{P}. The equation for defining the perceptual model can also be expressed in the following form: Q_{CALC}=(Q_{PM}/R_{PM}^{P})*R_{CALC}^{P}. The perceptual model parameter Q_{CALC} is a calculated encoding complexity control scalar that lies along the y-axis. The perceptual model parameter Q_{PM} is a perceptual model defining encoding complexity control scalar that is predefined in one embodiment and dynamically adjusted during encoding of a video sequence in another embodiment of the invention. The perceptual model parameter R_{CALC} is a bitrate that is calculated from preceding bitrates. The perceptual model parameter R_{PM} is a perceptual model defining bitrate that is predefined. In another embodiment of the invention the perceptual model parameter R_{PM} is dynamically modified as a video sequence is encoded. The perceptual model parameter P is a predefined value that defines the curve of the perceptual model. For example, if P is 1.0 then the perceptual model is a non-tailored perceptual model. If P is greater than 1.0 (e.g., 2.0) then the perceptual model is a soft frame tailored perceptual model. If P is less than 1.0 (e.g., 0.5) then the perceptual model is a hard frame tailored perceptual model.

According to another embodiment of the invention, the perceptual model parameters Q_{PM} and R_{PM} are represented by a single perceptual model defining parameter as in the following equation: Q_{CALC}=(PM^{P})*R_{CALC}^{P} (wherein PM represents the single perceptual model defining parameter). In one embodiment of the invention, the single perceptual model defining parameter is static, while in another embodiment of the invention, the single perceptual model defining parameter is dynamic.

A soft frame is a frame in a video sequence of low complexity requiring a lower number of bits for coding the soft frame. A hard frame is a frame in a video sequence of high complexity requiring a greater number of bits for encoding the hard frame. The graph illustrated in FIG. 1 also includes a constant bitrate model (CBR) and a conventional variable bitrate (VBR) model as references.

The CBR model is a straight line that runs parallel to the y-axis illustrating encoding of various frames regardless of complexity with the same number of bits. The conventional VBR model is a straight line that runs parallel to the x-axis illustrating use of the same encoding complexity control scalar to encode various frames within a video sequence. The non-tailored perceptual model is a straight line composed of points equidistant from both the y-axis and the x-axis. The non-tailored perceptual model illustrates the combinations of bitrate and encoding complexity control scalar values that provide smooth and consistent perception of a video sequence comprised of an appropriately balanced number of hard and soft frames. The soft frame tailored perceptual model initially runs parallel above the non-tailored perceptual model and then begins to curve towards the y-axis as bitrate increases. The soft frame tailored perceptual model illustrates the combinations of bitrate and encoding complexity control scalar that provide smooth and consistent perception of a video sequence that includes a relatively large number of soft frames. The hard frame tailored perceptual model initially runs below the non-tailored perceptual model and curves towards the x-axis as the encoding complexity control scalar increases. The hard frame tailored perceptual model illustrates the combinations of bitrate and encoding complexity control scalar that provide a smooth and consistent perception of a video sequence that includes a relatively large number of hard frames.

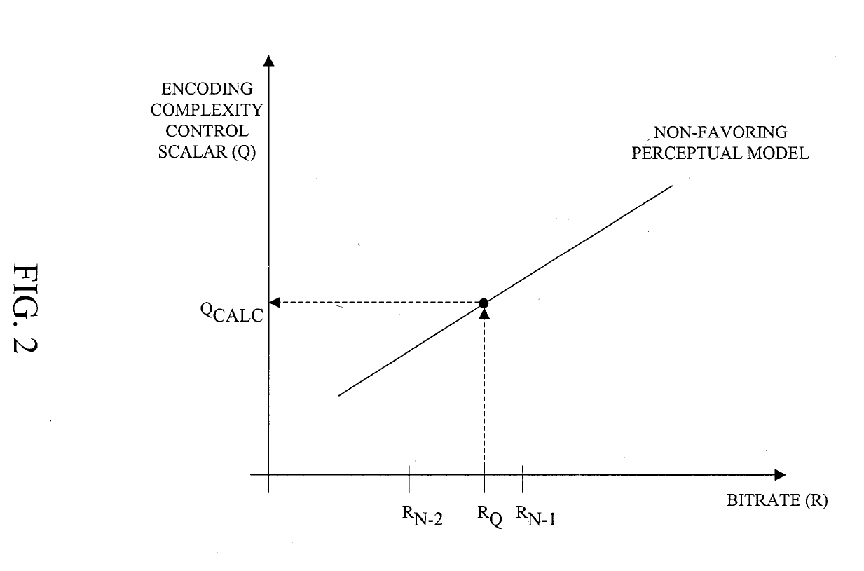

FIG. 2 is a diagram illustrating determination of an encoding complexity control scalar based on a non-tailored perceptual model according to one embodiment of the invention. In FIG. 2, 3 points are illustrated on the x-axis, which represents bitrate. The leftmost point on the x-axis (designated as R_{N-2}) indicates the bitrate of a frame N−2, wherein N represents the current frame to be encoded and N−2 represents an encoded frame that is two frames prior to the current frame. The rightmost point on the x-axis (designated as R_{N-1}) indicates the bitrate of a frame N-1, which is the frame encoded immediately prior to the current frame.

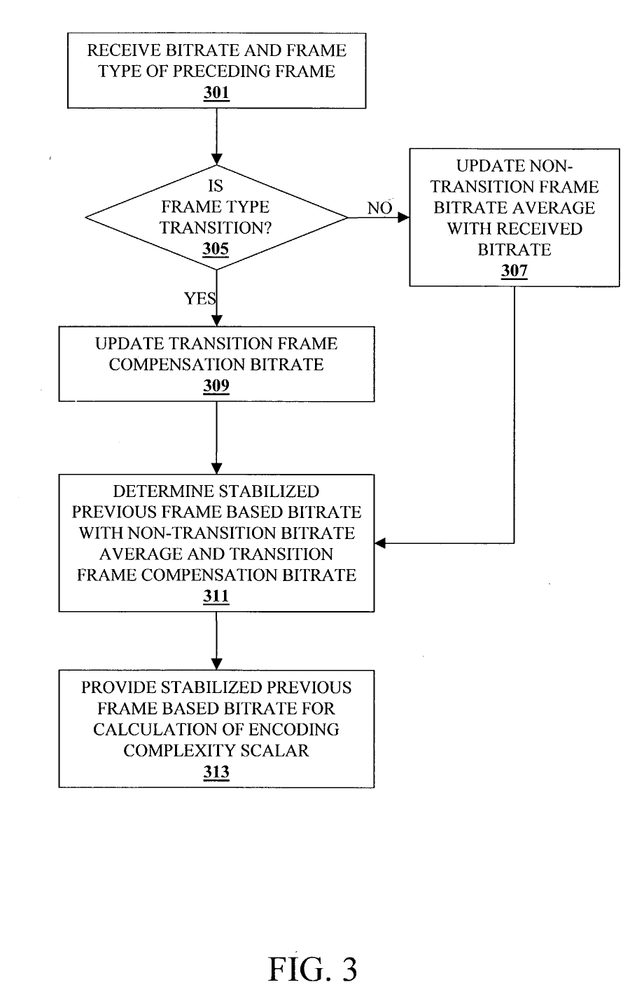

In the example illustrated in FIG. 2, a bitrate (designated as R_{Q}) falls on the x-axis between R_{N-2} and R_{N-1}. The point R_{Q} is a stabilized preceding encodings based bitrate which will be described in FIG. 3. After calculating R_{Q}, an encoding complexity control scalar that corresponds to the calculated R_{Q} according to the non-tailored perceptual model is determined. In one embodiment of the invention, the corresponding encoding complexity control scalar is provided for encoding a current frame. In another embodiment of the invention, the encoding complexity control scalar is bound. For example, the determined encoding complexity control scalar is bound as follows: 0.5*Q_{N-1}<=Q_{CALC}<=2*Q_{N-1} (Q_{N-1} is the determined Q for the preceding frame).

FIG. 3 is an exemplary flowchart for determining a stabilized previous encoding based bitrate according to one embodiment of the invention. At block 301, the bitrate and frame type of a preceding frame (i.e., an already encoded frame that precedes the current frame to be encoded) is received. At block 305, it is determined if the preceding frame is a transition frame (e.g., a scene change frame). If the preceding frame is not a transition frame, the control flows to block 307. If the preceding frame is a transition frame, then control flows to block 309.

At block 307, a non-transition frame bitrate average is updated with the received bitrate. From block 307, control flows to block 311. The non-transition frame bitrate average is calculated by averaging bitrates of previously encoded time filtered frames. For example, the preceding encoded non-transition frames closer in time to the current frame to be encoded are given greater weight (e.g., 100% of their value) than frames with less time proximity to the current frame. The time weight may be a continuous time filter, a discrete time filter, etc. According to one embodiment of the invention, the time weighed preceding non-transition frame bitrate average is calculated by RNT_{N}=RNT_{N-1}*K1+RN_{N}*K2, where K1 and K2 are coefficients which define how fast the system reacts to sudden video difficulty changes. RN_{N} is equal to the last previously encoded non-transitional frame bitrate.

At block 309, a transition frame compensation bitrate is updated with the received bitrate. The transition frame compensation bitrate is calculated by averaging the bitrates of transition frames over certain periods of time of the video sequence and by determining a compensation value to be added to the time weighed preceding non-transition frame bitrate average. According to one embodiment invention, the preceding transition frame compensation bitrate is calculated by the following formula: RL_{N}−RNTL_{N}. RL_{N}=RL_{N-1}*K3+R_{N}*K4 where R_{N} is the previously encoded frame bitrate, K3 and K4 are coefficients which define a slow reaction infinite response filter. RNTL_{N}=RNTL_{N-1}*K3+RN_{N}*K4 where R_{N} is the previously encoded non-transitional frame bitrate, K3 and K4 are the same coefficients as before which define a slow reaction infinite response filter.

At block 311, a stabilized preceding encodings based bitrate is determined with the preceding encoded transition frame based compensation bitrate and the preceding encoded non-transition frame based bitrate average. The addition of the preceding encoded transition frame compensation bitrate stabilizes the determined value (i.e., the stabilized preceding encodings based bitrate follows the bitrate average with a delay and stabilization to compensate for variations between different frame types). At block 313, the stabilized time weighed preceding encodings based bitrate is provided for calculation of an encoding complexity control scalar.

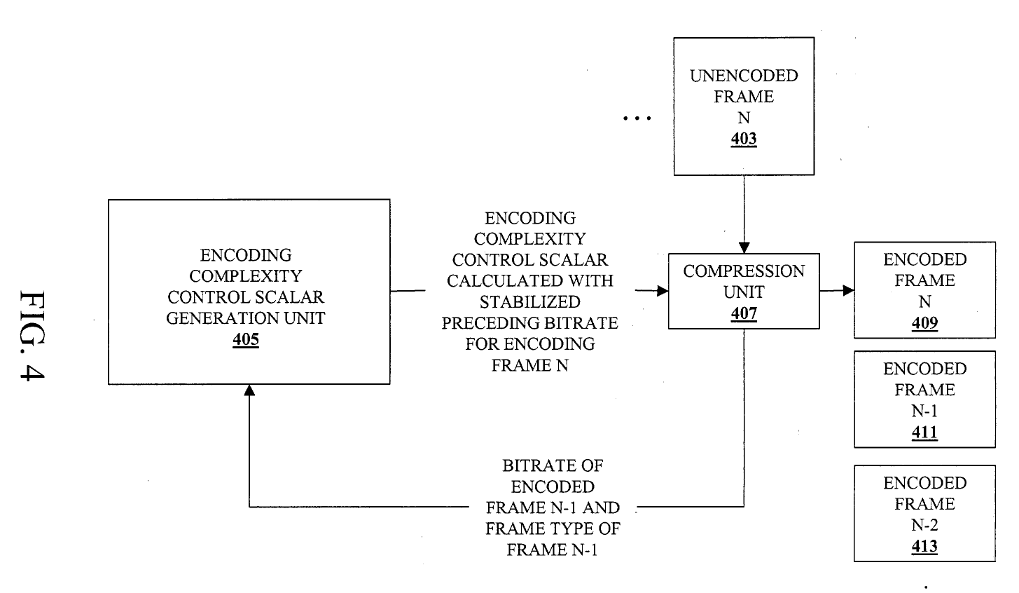

FIG. 4 is an exemplary diagram of an encoding complexity control scalar generation unit and an encoder according to one embodiment of the invention. Frames of a video sequence are encoded by an compression unit 407. In FIG. 4, an encoded frame N−1 411 and an encoded frame N−2 413 have been encoded by the compression unit 407. After the compression unit 407 encodes the encoded frame N−1 411, the compression unit 407 sends the bitrate of the encoded frame N−1 411 and the frame type of the encoded frame N−1 411 to an encoding complexity control scalar generation unit 405. The encoding complexity control scalar generation unit 405 uses the bitrate received from the compression unit 407 to calculate a stabilized time weighed preceding encodings based bitrate as described in FIG. 3. The encoding complexity control scalar generation unit 405 then determines an encoding complexity control scalar with a perceptual model equation, as discussed above in FIG. 2, and the stabilized time weighed preceding encodings based bitrate. The encoding complexity control scalar generation unit 405 then sends the encoding complexity control scalar to the compression unit 407. The compression unit 407 then uses the received encoding complexity control scalar to encode unencoded frame N 403 to generate encoded frame N 409.

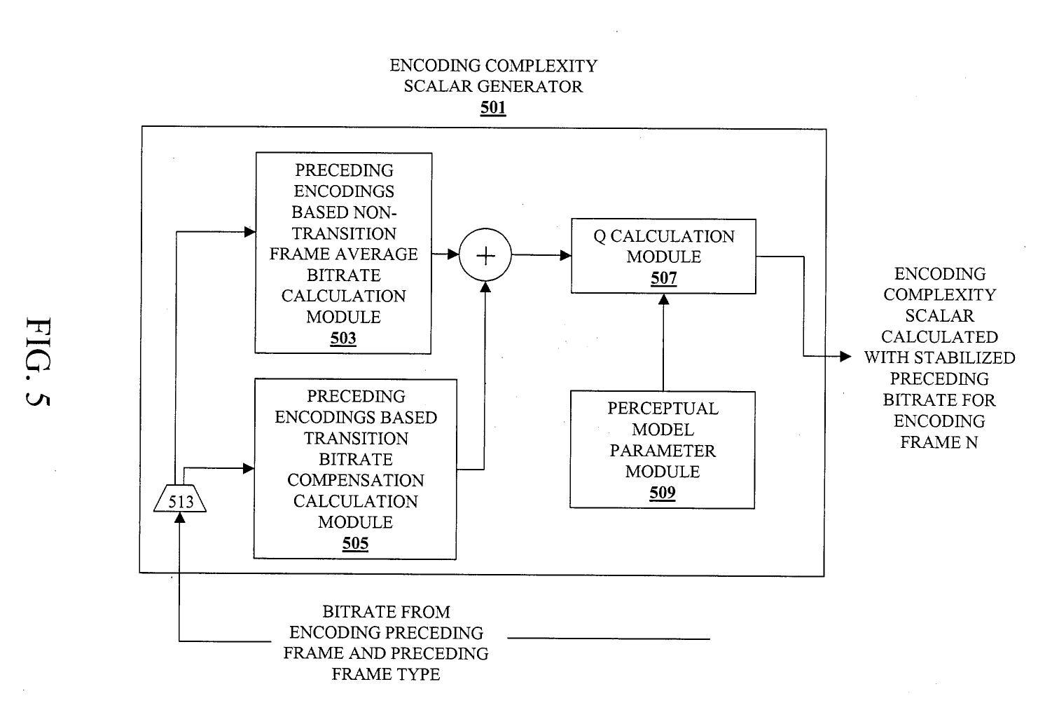

FIG. 5 is an exemplary diagram of an encoding complexity control scalar generation unit according to one embodiment of the invention. An encoding complexity control scalar generation unit 501 includes a multiplexer 513, a preceding encoded non-transition frame average bitrate calculation module 503, and a preceding encoded transition bitrate compensation calculation module 505. The preceding encoded non-transition frame average bitrate calculation module 503 and the preceding encoded transition bitrate compensation calculation module 505 are both coupled with the multiplexer 513. The encoding complexity control scalar generation unit 501 also includes a perceptual model parameter module 509 and an encoding complexity control scalar calculation module 507. The preceding encoded non-transition frame average bitrate calculation module 503, the preceding encoded transition bitrate compensation calculation module 505, and the perceptual model parameter module 509, are all coupled with the encoding complexity control scalar calculation module 507.

The encoding complexity control scalar generation unit 501 receives a preceding encoded frame's bitrate and a frame type of the preceding encoded frame. In an alternative embodiment of the invention, a frame type is not received. Instead, the encoding complexity control scalar (Q) generation unit 501 determines the frame type from the bitrate received. The multiplexer 513 receives the bitrate and sends it to the preceding encoded non-transition frame average bitrate calculation module 503 if the frame is non-transition and to the preceding encoded transition frame bitrate compensation calculation module 505 if the frame is transition. Output of the preceding encoded non-transition frame average bitrate calculation module 503 and the preceding encoded transition frame bitrate compensation calculation module 505 are added together and sent to the Q calculation module 507. In an alternative embodiment of the invention, the output of the preceding encoded non-transition frame average bitrate calculation module 503 and the preceding encoded transition frame bitrate compensation calculation module 505 are sent to the Q calculation module 507 without modification.

The perceptual model parameter module 509 outputs parameters that define the perceptual model used for calculating the encoding complexity control scalar. The Q calculation module 507 then provides the encoding complexity control scalar calculated with the stabilized preceding encodings based bitrate for encoding a current frame as output from the encoding complexity control scalar generation unit 501.

Shifting the Perceptual Model to Provide Smooth Bit Utilization

Another technique to provide consistent visual quality of a video sequence is to control bit utilization. A target bit utilization range can be established based on characteristics of a video sequence (e.g., the total number of bits for encoding the video sequence (“bit budget”), the video sequence duration, complexity of the video sequence, etc.). Based on the established target bit utilization range, variables are calculated to modify at least one perceptual model defining parameter, such as Q_{PM}. The perceptual model defining parameter is modified to shift the perceptual model to a position that will result in an encoding complexity control scalar being used to encode a current frame with a number of bits within the target bit utilization range.

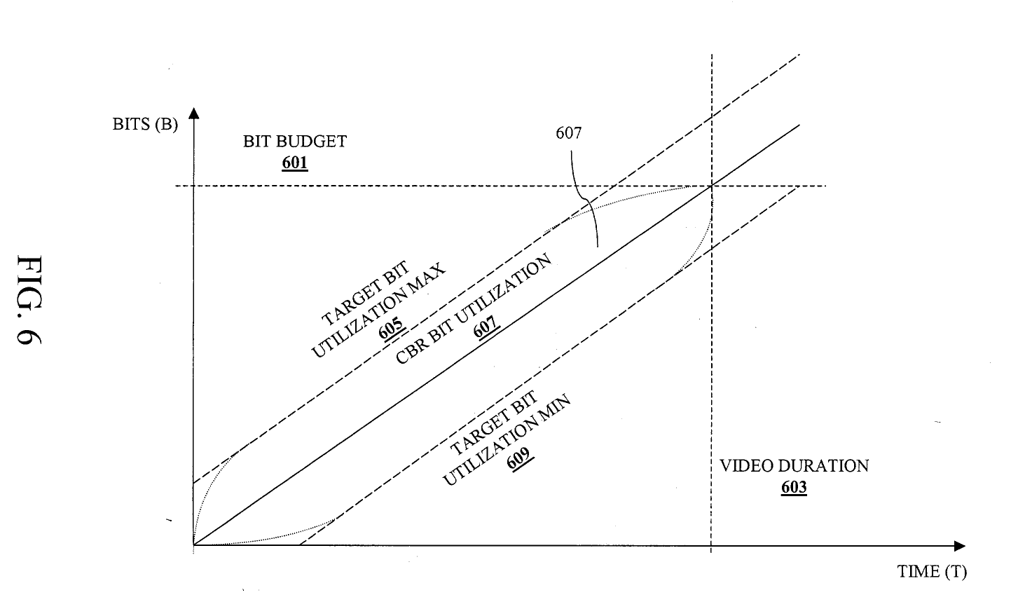

FIG. 6 is a graph illustrating target bit utilization range over a video sequence according to one embodiment of the invention. In FIG. 6, a y-axis is defined as bits (B) and an x-axis is defined in terms of time (T). A dashed line 601 running parallel to the x-axis indicates a bit budget for a video sequence. A dashed line 603 running horizontal to the y-axis indicates a video sequence duration. A solid diagonal line 607 that runs 45 degrees from the x-axis indicates a constant bitrate (CBR) bit utilization. The video sequence encoded according to the CBR bit utilization line 607 encodes each frame of a video sequence with the same number of bits. A dashed line 605 and a dashed line 609 respectively indicate a target bit utilization maximum and a target bit utilization minimum of a target bit utilization range for a video sequence. The target bit utilization maximum line 605 runs parallel above the CBR bit utilization line 607. The target bit utilization minimum line 609 runs parallel below the CBR bit utilization line 607. In FIG. 6, the target bit utilization range defined by the target bit utilization maximum 605 and the target bit utilization minimum 609 is constant throughout the video sequence. Another embodiment of invention, illustrated in FIG. 6, shows a tapering of the target bit utilization range. At the beginning of the video sequence, the target bit utilization range increases. At the end of the video sequence, the target bit utilization range decreases. Confining bit utilization for encoding a video sequence within a target bit utilization range changes an encoding complexity control scalar slowly while fulfilling predetermined bitrate constraints and maintaining visual quality consistency in contrast to perceivable fluctuations in visual quality resulting from CBR bit utilization.

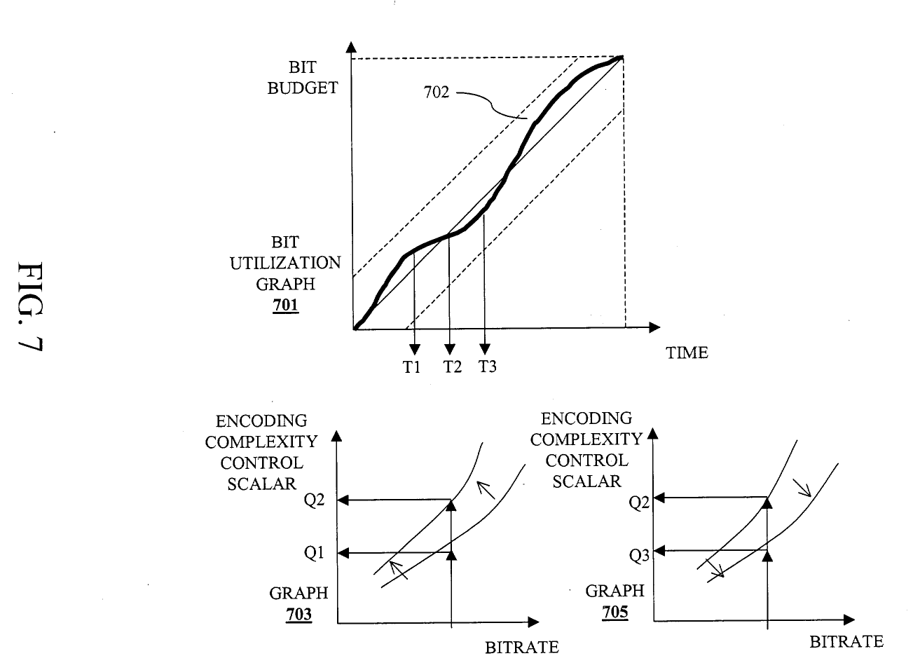

FIG. 7 is a diagram illustrating conceptual interaction between a bit utilization graph and a perceptual model according to one embodiment of the invention. In FIG. 7, a bit utilization graph 701 for a video sequence is illustrated. The bit utilization graph 701 has a constant target bit utilization range. In addition, actual bit utilization for a video sequence is illustrated in the bit utilization graph 701 as a line 702. Three points in time (T1, T2, T3) are identified in the bit utilization graph 701 along the time axis.

FIG. 7 also includes a perceptual model graph that changes across time. A perceptual model graph 703 that corresponds with the time T1 on the bit utilization graph 701 shows a diagonal shift of a perceptual model from a beginning position prior to time T1 to a position to the left and above the perceptual model's beginning position. The perceptual model graph 703 also illustrates a different corresponding encoding complexity control scalar for a single bitrate value due to the perceptual model shift. A perceptual model graph 705 illustrates another shift in the perceptual model. The shift in the perceptual model illustrated in the perceptual model graph 705 corresponds to the time T2. At the time T2 on the bit utilization graph 701 bit utilization is decreasing but the slope of the line is increasing. Although the bit utilization line 702 at time T2 is decreasing and falls below the CBR bit utilization line, the perceptual model in the perceptual model graph 705 shifts down and to the right because of the changing slope in the bit utilization line 702. This shift in the perceptual model avoids drastic changes in bit utilization over the video sequence and provides for a smooth bit utilization line 702. The shifts in the perceptual model illustrated in the perceptual model graphs 703 and 705 are typically small shifts resulting in small changes in the encoding complexity control scalar.

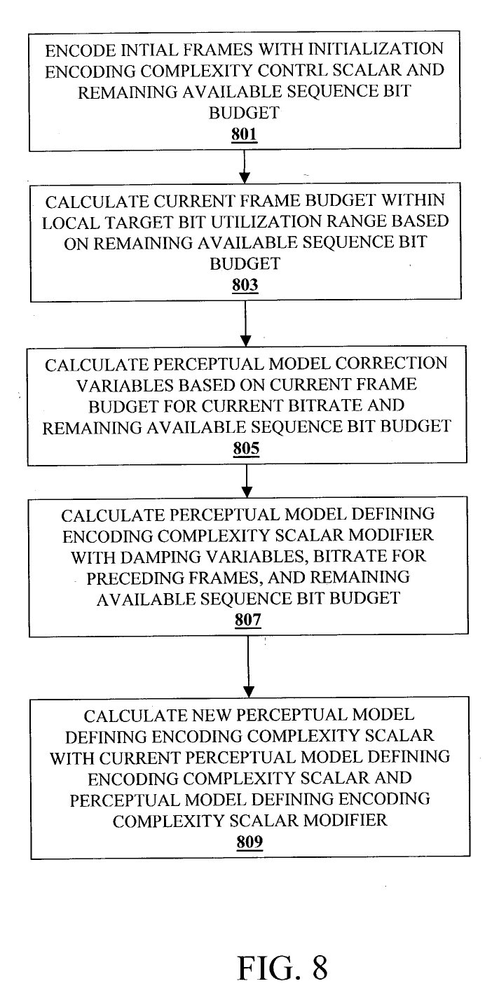

FIG. 8 is an exemplary flowchart for calculating any perceptual model defining parameter according to one embodiment of invention. In FIG. 8, it is assumed that the perceptual model defining parameter is a perceptual model defining encoding complexity control scalar as an example to aid in illustration of the invention. At block 801, initial frames of a video sequence are encoded with an initialization encoding complexity control scalar and a remaining available video sequence bit budget. At block 803, a model reaction parameter depending on a local bit utilization range (i.e., the area within the target bit utilization range at a given time) of the target bit utilization range is calculated based on a remaining available video sequence bit budget.

Model reaction parameter=Bytes per frame/Local bit utilization range

At block 805, perceptual model correction parameters (i.e., oscillation perceptual model correction parameters or logarithmic perceptual model correction parameters) are calculated based on the current frame budget for a current bitrate and the remaining available video sequence bit budget.

D_{R}=Model reaction parameter/Bytes per frame (D_{R} being a bitrate oscillation damping variable)

D_{B}=(Model reaction parameter)²/Bytes per frame (D_{B} being bit budget control variable)

At block 807, a perceptual model defining encoding complexity control scalar modifier is calculated with the perceptual model correction parameters, bitrate for the preceding frame, and remaining available video sequence bit budget.

Q_{mod}=R_{N-1}*D_{R}+B*D_{B} (B being the difference between current bit budget usage and ideal bit budget usage)

At block 809, a new perceptual model defining encoding complexity control scalar is calculated with the current perceptual model defining encoding complexity control scalar and the perceptual model defining encoding complexity control scalar modifier.

Q_{PM}=Q_{mod}*Q_{PM}+Q_{PM}

The bit utilization control technique described in FIG. 8 assumes a single pass VBR environment. The bit utilization control technique may alternatively be applied in a multi-pass VBR environment. For example, on a first of two passes, the perceptual model defining encoding complexity control scalar is a predefined value based on information known about the video sequence (e.g., bit budget, resolution, etc.). On the second pass, the perceptual model defining encoding complexity parameter is determined with the perceptual model defining encoding complexity control scalar of the first pass and a final preceding encodings based of the first pass as indicated in the following equation: Qₚₐₛₛ₂=Qₚₐₛₛ₁*(R_{Q1}/Rₚₘ)^{P+}. (R_{Q1} being a stabilized time weighed bitrate from the first pass and R_{PM} being a perceptual model defining bitrate parameter).

Generating an Encoding Complexity Control Scalar Based on a Dynamic Perceptual Model for Smooth Bit Utilization

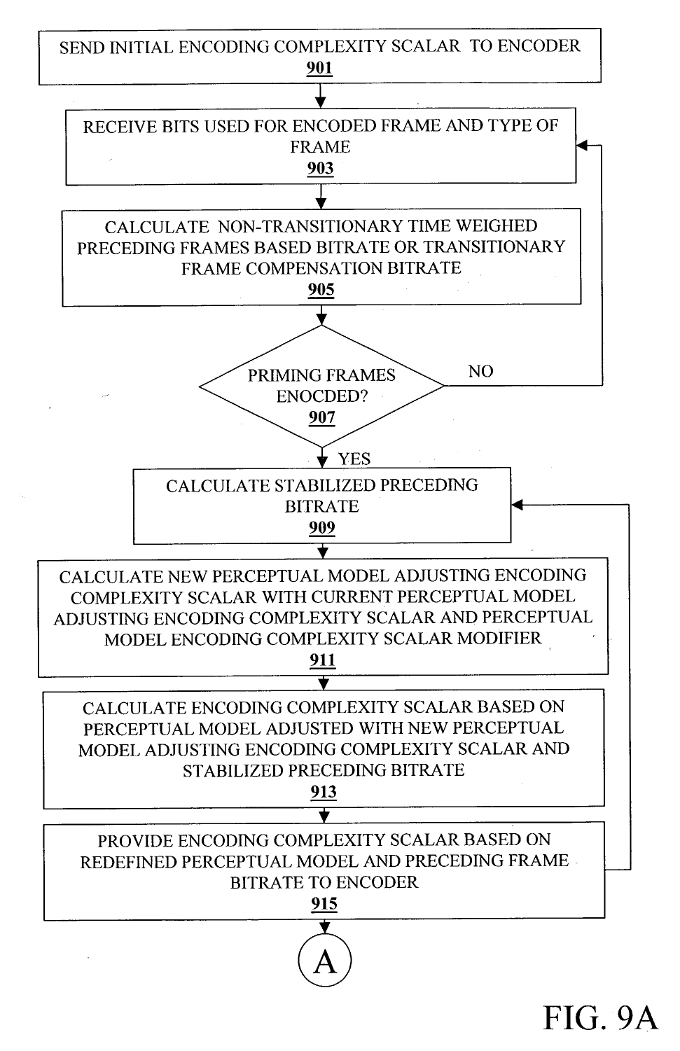

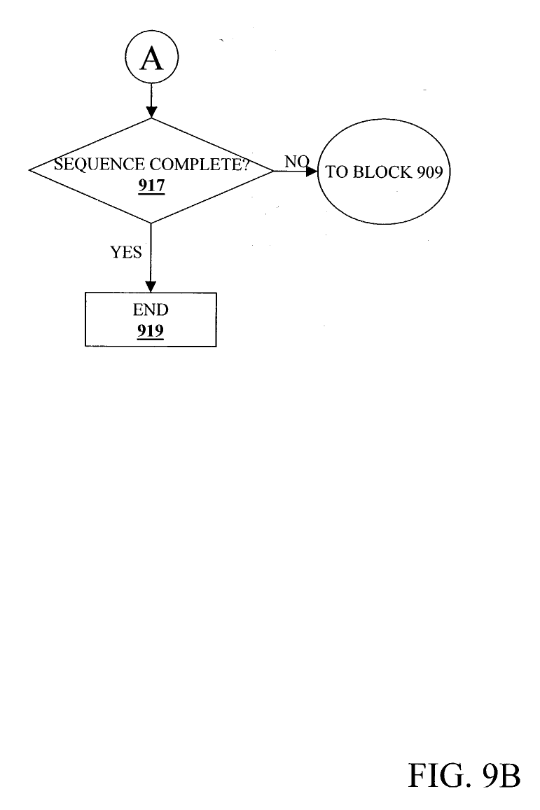

FIG. 9A is a flowchart for calculating an encoding complexity control scalar based on a bit utilization control adaptive perceptual model according to one embodiment of invention. At block 901, and initial encoding complexity control scalar is sent to an encoder for encoding a frame. At block 903, the number of bits used for encoding the frame and the type of the frame are received. At block 905, a preceding encodings based time weighed non-transition frame bitrate or a preceding encodings based time weighed transition frame compensation bitrate is calculated. A block 907 is determined if the priming frames have been encoded. Various embodiments of the invention can define priming frames differently (e.g., a certain number of frames, passing of a certain amount of time, etc.). If all the priming frames have been encoded, the control flows block 909. If all of the priming frames have not been encoded, the control flows back to block 903.

At block 909, a stabilized time weighed preceding encodings based bitrate is calculated. At block 91 1, a new perceptual model defining encoding complexity control scalar is calculated with a current perceptual model defining encoding complexity control scalar and a perceptual model encoding complexity control scalar modifier, similar to the description in FIG. 8. At block 913, an encoding complexity control scalar based on a perceptual model adjusted with a new perceptual model defining encoding complexity control scalar and a stabilized time weighed preceding encodings based bitrate is calculated. At block 915, the calculated encoding complexity control scalar based on the adjusted perceptual model and the stabilized time weighed preceding encodings based bitrate are provided to the encoder for encoding a current frame. From block 915 control flows to block 917 in FIG. 9B.

FIG. 9B is a flowchart continuing from the flowchart of FIG. 9A according to one embodiment of the invention. At block 917, it is determined if the video sequence is complete. If the video sequence is not complete, the control flows back to block 909. If the video sequence is complete, then control flows to block 919 where processing ends.

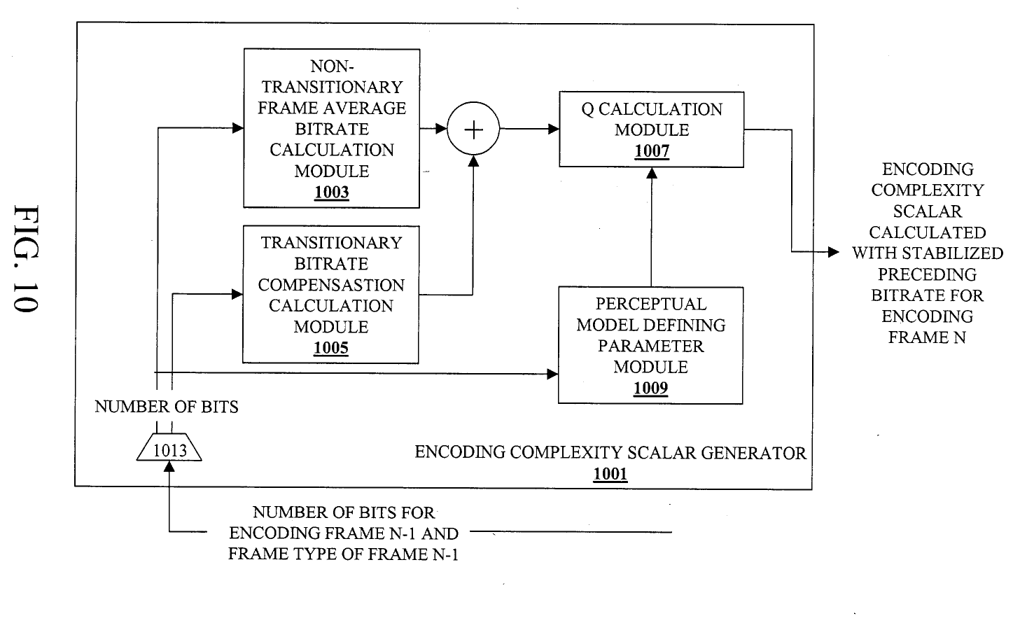

FIG. 10 is an exemplary diagram of an encoding complexity control scalar generation unit with a perceptual model defining parameter module according to one embodiment of the invention. An encoding complexity control scalar generation unit 1001 includes a multiplexer 1013, a preceding encoded non-transition frame average bitrate calculation module 1003, and a preceding encoded transition bitrate compensation calculation module 1005. The preceding encoded non-transition frame average bitrate calculation module 1003 and the preceding encoded transition frame bitrate compensation calculation module 1005 are coupled with the multiplexer 1013. The encoding complexity control scalar generation unit 1001 additionally includes a perceptual model defining parameter module 1009 and an encoding complexity control scalar calculation module 1007. The perceptual model defining parameter module 1009 is also coupled with the multiplexer 1013. The preceding encoded non-transition frame average bitrate calculation module 1003, the preceding encoded transition bitrate compensation calculation module 1005, and the perceptual model parameter module 1009 are all coupled with the encoding complexity control scalar calculation module 1007.

The encoding complexity control scalar generation unit 1001 receives a preceding encoded frame's bitrate and a frame type of the preceding encoded frame. In an alternative embodiment of the invention a frame type is not received. Instead, the encoding complexity control scalar (Q) generation unit 1001 determines the frame type from the bitrate received. The multiplexer 1013 receives the bitrate and sends it to the preceding encoded non-transition frame average bitrate calculation module 1003 if the frame is non-transition and to the preceding encoded transition frame bitrate compensation calculation module 1005 if the frame is transition. The number of bits used to encode the preceding frame are also sent to the perceptual model defining parameter module 1009. Ouput of the preceding encoded non-transition frame average bitrate calculation module 1003 and the preceding encoded transition frame bitrate compensation calculation module 1005 are added together and sent to the Q calculation module 1007. In an alternative embodiment of the invention, the output of the preceding encoded non-transition frame average bitrate calculation module 1003 and the preceding encoded transition frame bitrate compensation calculation module 1005 are sent to the Q calculation module 1007 without modification.

The perceptual model defining parameter module 1009 outputs perceptual model defining parameters calculated with the number of bits received from the multiplexer 1013. The operations performed by the perceptual model defining parameter module 1009 are similar to those operations described in FIG. 8. The Q calculation module 1007 provides as output from the encoding complexity control scalar generation unit 1001 the encoding complexity control scalar calculated with the stabilized preceding time weighed encodings based bitrate for encoding a current frame.

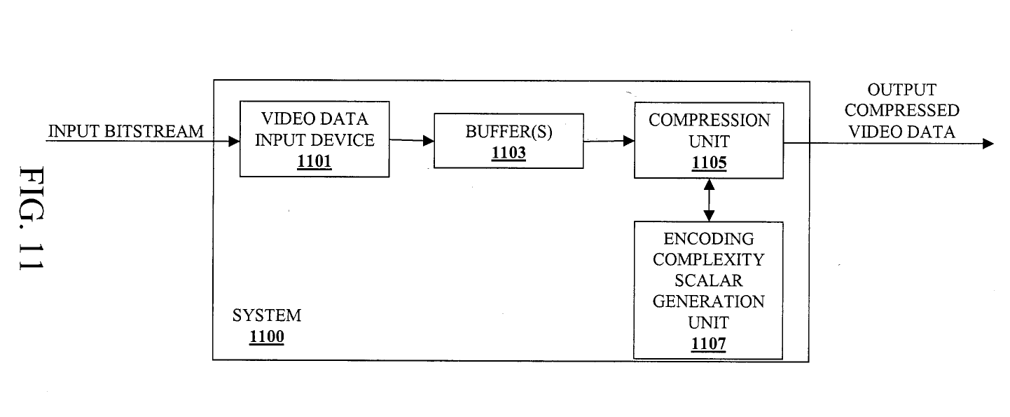

FIG. 11 is an exemplary diagram of a system with an encoding complexity control scalar generation unit according to one embodiment of the invention. In FIG. 11, a system 1100 includes a video input data device 1101, a buffer(s) 1103, a compression unit 1105, and an encoding complexity control scalar generation unit 1107. The video input data device 1101 receives an input bitsream. The video input data device 1101 passes the input bitstream to the buffer(s) 1103, which buffers frames within the bitstream. The frames flow to the compression unit 1105, which compresses the frames with input from the encoding complexity control scalar generation unit 1I107. The compression unit 1 105 also provides data to the encoding complexity generation unit 1107 to calculate the encoding complexity control scalar that is provided to the compression unit 1105. The compression unit 1105 outputs compressed video data.

The system described above includes memories, processors, and/or ASICs. Such memories include a machine-readable medium on which is stored a set of instructions (i.e., software) embodying any one, or all, of the methodologies described herein. Software can reside, completely or at least partially, within this memory and/or within the processor and/or ASICs. For the purpose of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Alternative Embodiments

While the invention has been described in terms of several embodiments, those skilled in the art will recognize that the invention is not limited to the embodiments described. For instance, while the flow diagrams show a particular order of operations performed by certain embodiments of the invention, it should be understood that such order is exemplary (e.g., alternative embodiments may perform the operations in a different order, combine certain operations, overlap certain operations, etc.). For example, with reference to FIG. 9, block 911 is performed before block 909 in an alternative embodiment of the invention. In another embodiment of the invention, blocks 909 and 911 are performed in parallel.

Furthermore, although the Figures have been described with reference to transition frames and non-transition frames, alternative embodiments of the invention compress video sequences that include a variety of frame types (e.g., I, P and B frames). In one embodiment of the invention, bitrates within a certain threshold are utilized in calculating a preceding encodings based bitrate average while bitrates exceeding the threshold are utilized in calculating a compensation bitrate.

Thus, the method and apparatus of the invention can be practiced with modification and alteration within the spirit and scope of the appended claims. The description is thus to be regarded as illustrative instead of limiting on the invention.

We claim:

1. A computer implemented method comprising:
calculating a bitrate value that follows with stabilizing delay the actual bitrates of previous frames;
determining a current quantization coefficient with the calculated bitrate value and a perceptual model;
limiting the current quantization coefficient's rate of change based on a previous quantization coefficient; and
encoding a frame with the limited current quantization coefficient.

2. The computer implemented method of claim 1 wherein the perceptual model is defined by the following equation: Q_{PM}*(R_{CALC}/R_{PM})^{P}.

3. The computer implemented method of claim 1 wherein the current quantization coefficient's rate of change is limited within 0.5*Q_{N-1}<=Q_{CALC}<=2*Q_{N-1}, wherein Q_{N-1} is the Q determined for a preceding frame.

4. The computer implemented method of claim 1 wherein the bitrate value =RNT_{N} +RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

5. A computer implemented method comprising:
determining an encoding complexity control scalar based on a perceptual model with a stabilized time weighed preceding encodings based bitrate;
bounding the determined encoding complexity control scalar based on a set of one or more previous encoding complexity control scalars used to encode a set of one or more preceding frames; and
encoding a current frame using the bounded encoding complexity control scalar.

6. The computer implemented method of claim 5 wherein the perceptual model is defined by the following equation: Q_{PM}*(R_{CALC}/R_{PM})^{P}.

7. The computer implemented method of claim 5 wherein the encoding complexity control scalar is bounded by 0.5*Q_{N-1}<=Q_{CALC}<=2*Q_{N-1}, wherein Q_{N-1} is the Q determined for a preceding frame.

8. The computer implemented method of claim 5 wherein the stabilized time weighed preceding encodings based bitrate=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RNN is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

9. A computer implemented method comprising:
establishing a target bit utilization range for a duration of a plurality of video frames based on information known about the plurality of video frames;
calculating a model reaction parameter within the target bit utilization range based on the remaining available bits for the plurality of video frames;
calculating a perceptual model correction parameters with the calculated current frame's budget and the remaining available bits for the plurality of video frames; and
modifying a current perceptual model defining parameter in accordance with the calculated perceptual model correction parameters, a preceding frame's bitrate, and the remaining available bits for the plurality of video frames.

10. The computer implemented method of claim 9 wherein the model reaction parameter is the quotient of the number of bits per frame and a local bit utilization range.

11. The computer implemented method of claim 9 wherein the perceptual model correction parameters include a bitrate oscillation damping variable (D_{R}) and a bit budget control variable (D_{B}), calculated according to the following equations:
D_{R}=Model reaction parameter/Bytes per frame (D_{R} being a bitrate oscillation damping variable), and
D_{B}=(Model reaction parameter)²/Bytes per frame (D_{B} being bit budget control variable).

12. A computer implemented method comprising:
determining an encoding complexity control scalar with a perceptual model and a preceding encodings based bitrate to encode a set of one or more frames in a video;
updating the preceding encodings based bitrate after encoding each frame of the set of frames in the video; and
shifting the perceptual model in accordance with controlling bit utilization over the video's duration.

13. The computer implemented method of claim 12 wherein the perceptual model is defined by the following equation: Q_{PM}*(R_{CALC}/R_{PM})^{P}.

14. The computer implemented method of claim 12 wherein the stabilized time weighed preceding encodings based bitrate=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K₃ and K₄ are coefficients which define a slow reaction infinite response filter, and RNTL_{N}=RNTL_{N-1}*K3+RN_{N}*K4.

15. A computer implemented method comprising:
encoding a plurality of frames of a video for consistent perceived visual quality of the video with an encoding complexity control scalar calculated in accordance with a perceptual model and adjusted for each of the plurality of frames in accordance with an average bitrate of a set of one or more preceding encoded frames, the average bitrate being adjusted to compensate for preceding encoded frames with a bitrate exceeding a certain threshold; and
modifying the perceptual model to control bit utilization for encoding the video.

16. The computer implemented method of claim 15 wherein the perceptual model is defined by the following equation: Q_{PM}*(R_{CALC}/R_{PM})^{P}.

17. The computer implemented of claim 15 wherein the average bitrate is=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

18. An apparatus comprising:
an encoding complexity control scalar generation unit including
a perceptual model parameter unit to host perceptual model parameters,
an input bitrate calculation unit to calculate an input bitrate based on previously encoded frames bitrates, and
an encoding complexity control scalar calculation unit coupled with the perceptual model parameter unit and the input bitrate calculation unit, the encoding complexity control scalar calculation unit to calculate an encoding complexity control scalar with perceptual model parameters from the perceptual model parameter unit and an input bitrate from the input bitrate calculation unit; and
a video compression unit coupled with the encoding complexity generation unit to receive an encoding complexity control scalar and to compress video, the video compression unit including
a quantization unit,
a motion compensation unit, and
an encoding unit.

19. The apparatus of claim 18 wherein the quantization unit is a DCT unit.

20. The apparatus of claim 18 further comprising an optical medium reading module coupled with the video compression unit.

21. A machine-readable medium having a set of instructions to cause a device to perform the following operations:
calculating a bitrate value that follows with stabilizing delay the actual bitrates of previous frames;
determining a current quantization coefficient with the calculated bitrate value and a perceptual model;
limiting the current quantization coefficient's rate of change based on a previous quantization coefficient; and
encoding a frame with the limited current quantization coefficient.

22. The machine-readable medium of claim 21 wherein the perceptual model is defined by the following equation: Q_{PM}*(R_{CALC}/R_{PM})^{P}.

23. The machine-readable medium of claim 21 wherein the current quantization coefficient's rate of change is limited within 0.5*Q_{N-1}<=Q_{CALC}<=2*Q_{N-1}, wherein Q_{N-1} is the Q determined for a preceding frame.

24. The machine-readable medium of claim 21 wherein the bitrate value=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

25. A machine-readable medium having a set of instructions to cause a device to perform the following operations:
determining an encoding complexity control scalar based on a perceptual model with a stabilized time weighed preceding encodings based bitrate;
bounding the determined encoding complexity control scalar based on a set of one or more previous encoding complexity control scalars used to encode a set of one or more preceding frames; and
encoding a current frame using the bounded encoding complexity control scalar.

26. The machine-readable medium of claim 25 wherein the perceptual model is defined by the following equation: Q_{PM}*(R_{CALC}/R_{PM})^{P}.

27. The machine-readable medium of claim 25 wherein the encoding complexity control scalar is bounded by 0.5*Q_{N-1}<=Q_{CALC}<=2*Q_{N-1}, wherein Q_{N-1} is the Q determined for a preceding frame.

28. The machine-readable medium of claim 25 wherein the stabilized time weighed preceding encodings based bitrate=RNT_{N}+RL_{N}−RNTL_{N}, wherein RNT_{N}=RNT_{N-1} *K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

29. A machine-readable medium having a set of instructions to cause a device to perform the following operations:
establishing a target bit utilization range for a duration of a plurality of video frames based on information known about the plurality of video frames;
calculating a model reaction parameter within the target bit utilization range based on the remaining available bits for the plurality of video frames;
calculating a perceptual model correction parameters with the calculated current frame's budget and the remaining available bits for the plurality of video frames; and
modifying a current perceptual model defining parameter in accordance with the calculated perceptual model correction parameters, a preceding frame's bitrate, and the remaining available bits for the plurality of video frames.

30. The machine-readable medium of claim 29 wherein the model reaction parameter is the quotient of the number of bits per frame and a local bit utilization range.

31. The machine-readable medium of claim 29 wherein the perceptual model correction parameters include a bitrate oscillation damping variable (D_{R}) and a bit budget control variable (D_{B}), calculated according to the following equations:
D_{R}=Model reaction parameter/Bytes per frame (D_{R} being a bitrate oscillation damping variable), and
D_{B}=(Model reaction parameter)²/Bytes per frame (D_{B} being bit budget control variable).

32. A machine-readable medium having a set of instructions to cause a device to perform the following operations:
determining an encoding complexity control scalar with a perceptual model and a preceding encodings based bitrate to encode a set of one or more frames in a video;
updating the preceding encodings based bitrate after encoding each frame of the set of frames in the video; and
shifting the perceptual model in accordance with controlling bit utilization over the video's duration.

33. The machine-readable medium of claim 32 wherein the perceptual model is defined by the following equation: Q_{PM}*(R_{CALC}/R_{PM})^{P}.

34. The machine-readable medium of claim 32 wherein the stabilized time weighed preceding encodings based bitrate=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.

35. A machine-readable medium having a set of instructions to cause a device to perform the following operations:
encoding a plurality of frames of a video for consistent perceived visual quality of the video with an encoding complexity control scalar calculated in accordance with a perceptual model and adjusted for each of the plurality of frames in accordance with an average bitrate of a set of one or more preceding encoded frames, the average bitrate being adjusted to compensate for preceding encoded frames with a bitrate exceeding a certain threshold; and
modifying the perceptual model to control bit utilization for encoding the video.

36. The machine-readable medium of claim 34 wherein the perceptual model is defined by the following equation: Q_{PM}*(R_{CALC}/R_{PM})^{P}.

37. The machine-readable medium of claim 34 wherein the average bitrate is=RNT_{N}+RL_{N}−RNTL_{N}, wherein RNT_{N}=RNT_{N-1}*K1+RN_{N}*K2, where K1 and K2 are coefficients which define how fast a system reacts to sudden difficulty changes between frames and RN_{N} is equal to the last previously encoded non-transitional frame bitrate, RL_{N}=RL_{N-1}*K3+R_{N}*K4 where R_{N} is the previously encoded frame bitrate, K3 and K4 are coefficients which define a slow reaction infinite response filter, and RNTL_{N}=RNTL_{N-1}*K3+RN_{N}*K4.
